(19) United States
(12) Patent Application Publication
(10) Pub. No.: US 2014/0019057 A1
(43) Pub. Date: Jan. 16, 2014

(54) Microseismic Event Verification Using Sub-stacks

(71) Applicant: David E. Diller, Greenwood Village, CO (US)

(72) Inventor: David E. Diller, Greenwood Village, CO (US)

(73) Assignee: NANOSEIS LLC, Greenwood Village, CO (US)

(21) Appl. No.: 13/942,654

(22) Filed: Jul. 15, 2013

Related U.S. Application Data
(60) Provisional application No. 61/672,043, filed on Jul. 16, 2012.

(51) Int. Cl. G01V 1/28; G01V 1/34

(52) U.S. Cl. CPC G01V 1/288; G01V 1/34
USPC 702/16; 702/17

(57) ABSTRACT

Disclosed herein are various embodiments of discriminating between small microseismic events and false events comprising identifying candidate events, and creating sub-stacks of the microseismic data traces. Analysis of the sub-stacks shows distinct differences between real microseismic events and false events created by noise bursts. Further discrimination between real and false events is achieved by visual or automated analysis of the reverberations and patterns of polarity reversal associated with real microseismic events, which are more clearly visible in the sub-stacks than in the raw microseismic data. The methods described herein are applicable to surface, downhole and buried array microseismic data.

### FIELD

Various embodiments described herein relate to the field of seismic data acquisition and processing, and devices, systems and methods associated therewith.

### BACKGROUND

Microseismic monitoring of hydraulic fractures is the study of very small seismic events, typically less than Richter magnitude 0, that are induced during hydraulic fracturing. Hydraulic fracturing is the process of creating or enhancing fractures in rock formations by pumping high pressure fluid and proppant into the rocks, thereby increasing the ability to produce hydrocarbons from the rock formation. The purpose of microseismic monitoring is to determine if the hydraulic fracturing has unintended effects such as opening fractures into shallow layers and freshwater aquifers, and to determine if the hydraulic fracturing has the intended effects within the hydrocarbon-bearing rock formation. Microseismic monitoring may be performed in real time during the hydraulic fracturing operation, in which case the fracturing operation can be modified or stopped if unintended fracturing effects are evident.

Microseismic monitoring is typically performed by placing arrays of geophones in adjacent wells, or at or near the earth's surface. These instruments sense the ground motion caused by the microseismic events, which is then used to determine the event location. Microseismic events produce very small ground motions, and surface or near-surface microseismic monitoring is limited by noise contamination. Noise contamination includes surface waves, refracted waves, and reflected waves from surface noise sources. Noise contamination masks microseismic signals, and noise contamination can lead to the false identification of microseismic events.

What is desired are improved techniques wherein microseismic data are acquired and processed in such a manner that real microseismic events can be distinguished from noise and false microseismic events, thereby allowing detection and location of more and smaller microseismic events. The resulting improvement in the confidence level associated with the microseismic events enables better determination of event locations that in turn may more accurately represent the effects of hydraulic fracturing, while avoiding false events that may misrepresent the effects of hydraulic fracturing.

### SUMMARY

In one embodiment, there is provided a method for discriminating between small microseismic events and false events comprising: obtaining a set of microseismic data traces recorded at a plurality of receivers; identifying at least one candidate event by applying a source scanning algorithm; for each candidate event; identifying an apparent location of the candidate event; correcting the microseismic data traces for the travel times from the apparent location of the candidate event to each corresponding receiver; organizing the time-corrected traces into a plurality of groups of traces; creating a plurality of sub-stack traces from the traces within each group and analyzing the sub-stacks to classify the candidate event as a microseismic event or a false event.

In another embodiment, there is provided a method for discriminating between small microseismic events and false events comprising: obtaining a set of microseismic data traces recorded at a plurality of receivers; identifying at least one candidate event by applying a source scanning algorithm; for each candidate event; identifying an apparent location of the candidate event; correcting the microseismic data traces for the travel times from the apparent location of the candidate event to each corresponding receiver; organizing the time-corrected traces into a plurality of groups of traces; creating a plurality of sub-stack traces from the traces within each group and analyzing the reverberations in the sub-stacks to classify the candidate event as a microseismic event or a false event.

In a further embodiment, there is provided a method for discriminating between small microseismic events and false events comprising: obtaining a set of microseismic data traces recorded at a plurality of receivers; identifying at least one candidate event by applying a source scanning algorithm; for each candidate event; identifying an apparent location of the candidate event; correcting the microseismic data traces for the travel times from the apparent location of the candidate event to each corresponding receiver; organizing the time-corrected traces into a plurality of groups of traces; creating a plurality of sub-stack traces from the traces within each group and analyzing polarity reversals in the sub-stacks to classify the candidate event as a microseismic event or a false event.

Further embodiments are disclosed herein or will become apparent to those skilled in the art after having read and understood the specification and drawings hereof.

### BRIEF DESCRIPTION OF THE DRAWINGS

Different aspects of the various embodiments of the invention will become apparent from the following specification, drawings and claims in which:

FIG. 1 shows one embodiment of a cross-sectional view of the earth and a microseismic data acquisition, recording and analysis system;

FIG. 2 shows the concept of the Source Scanning Algorithm;

FIG. 3 shows the subsurface grid of voxels and surface receivers for the Source Scanning algorithm;

FIG. 4 shows the process of creating sub-stacks;

FIG. 5A shows microseismic data from a small microseismic event;

FIG. 5B shows an enlargement of a section of microseismic sub-stacks;

FIG. 6A shows a seismic data display with data from a false event;

FIG. 6B shows an enlargement of a section of microseismic sub-stacks;

FIG. 7 shows data from a large microseismic event, in which reverberations are seen and

FIG. 8 shows a large microseismic event with a polarity reversal.

The drawings are not necessarily to scale. Like numbers refer to like parts or steps throughout the drawings.

### DETAILED DESCRIPTIONS OF SOME EMBODIMENTS

In the following description, specific details are provided to impart a thorough understanding of the various embodiments of the invention. Upon having read and understood the specification, claims and drawings hereof, however, those skilled in the art will understand that some embodiments of the invention may be practiced without hewing to some of the specific details set forth herein. Moreover, to avoid obscuring the invention, some well-known methods, processes and devices and systems finding application in the various embodiments described herein are not disclosed in detail.

Referring now to the drawings, embodiments of the present invention will be described. The invention can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth. In the drawings, some, but not all, possible embodiments are illustrated, and further may not be shown to scale.

For the first 100 years and more of oil exploration and production, wells were drilled almost exclusively in geologic formations that permitted production of oil and gas flowing under the natural pressures associated with the formations. Such production required that two physical properties of the geologic formation fall within certain boundaries. The porosity of the formation had to be sufficient to allow a substantial reserve of hydrocarbons to occupy the interstices of the formation, and the permeability of the formation had to be sufficiently high that the hydrocarbons could move from a region of high pressure to a region of lower pressure, such as when hydrocarbons are extracted from a formation. Typical geologic formations having such properties include sandstones.

In recent years, it has become apparent that large reserves of hydrocarbons are to be found in shale formations. Shale formations are typically not highly permeable, and therefore present formidable obstacles to production. The most common technique in use today that permits commercial production of hydrocarbons, and especially natural gas, from shale formations, is hydraulic fracturing. This technique can be also be applied to older wells drilled through non-shale formations to increase the proportion of hydrocarbons that can be extracted from them, thus prolonging the productive life of the well. Hydraulic fracturing was developed in the late 1940s, and has recently become much more widely used in the development of shale gas and oil.

Hydraulic fracturing involves pumping fluid under very high pressure into hydrocarbon-bearing rock formations to force open cracks and fissures and allow the hydrocarbons residing therein to flow more freely. The fluid is primarily water, and may contain chemicals to improve flow, and also “proppants” (an industry term for substances such as sand). When the fracturing fluid is removed, and the hydrocarbons are allowed to flow, the sand grains prop open the fractures and prevent their collapse, which might otherwise quickly stop or reduce the flow of hydrocarbons.

The progress of a fracturing operation must be monitored carefully. Well fracturing is expensive, and the fracturing process is frequently halted once its benefits become marginal. The high pressures associated with fracturing result in fractures that tend to follow existing faults and fractures, and can result in an uneven or unpredictable fracture zone. Fracturing fluid may also begin following an existing fault or fracture zone and then propagate beyond the intended fracture zone. Care must be taken not to interfere with existing production wells in the area. For these and other reasons, it is important that the fracturing operator be able to follow accurately the progress of the fluid front in the subsurface while the fluid is being injected into the well. Monitoring the fracturing process allows the operator to optimize the process and potentially to recover more gas or oil from the formation than would otherwise be possible. Techniques to monitor the hydraulic fracturing were introduced in the 1970s. See U.S. Pat. No. 3,739,871 to Bailey entitled “Mapping of Earth Fractures Induced by Hydrafracturing”, the disclosure of which is incorporated herein in its entirety.

Conventional surface seismic reflection surveys generally do not work well for monitoring the movement or positions of fluid fronts in the subsurface. The physical dimensions of fractures are often shorter than can be detected using conventional surface seismic reflection techniques. In addition, within a given geologic formation there may be no or low contrasts in seismic velocity, and as a result surface seismic reflection techniques cannot be used effectively to image fractures within the formation. Fractures also tend to scatter seismic energy, further reducing their detectability by conventional surface seismic reflection means.

An alternative approach to the problem of imaging fractures or fluid fronts within formations is known as “microseismicity”. Instead of using “active” surface seismic energy sources, “passive seismic” techniques are used to detect the times and locations of the origins of seismic energy generated in the subsurface of the earth by hydraulic fracturing. Seismic energy emitted by fracturing of a geologic formation, caused by the injection of high pressure fracturing fluid into the formation, is sensed and recorded. The objective then becomes determining the point of origin of the emitted seismic energy, which defines the location of the fracture. One method of locating fractures and faults in geologic formations is known as Seismic Emission Tomography (SET). Examples of SET techniques and processes are described in U.S. Pat. No. 6,389,361 to Geiser entitled “Method for 4D permeability analysis of geologic fluid reservoirs” (hereafter “the '361 patent”) and in U.S. Pat. No. 7,127,353 to Geiser entitled “Method and apparatus for imaging permeability pathways of geologic fluid reservoirs using seismic emission tomography” (hereafter “the '353 patent”), the disclosures of which are hereby incorporated by reference herein in their respective entireties.

Neither the time nor the exact location of the microseismic events are known in advance, and therefore monitoring must be continuous and must be performed over a wide area. Methods have evolved that require listening for extended periods of time, that is, hours, days or weeks, and using various algorithms to extract the very low level signals from the background noise. Data are recorded over an extended time period, with the duration of recording and the sampling interval being controlled by the objectives of the seismic data acquisition process, the characteristics of the events that generate the detected or sensed seismic energy, the distances involved, the characteristics of the subsurface, and other factors.

The data at each sensor are recorded as a time series of amplitude values corresponding to the seismic energy detected at the sensor. Such time series are referred to as “traces”. The data recorded at each sensor location are then filtered and processed using various processing techniques and software, which convert the data into a series of values within gridded subsurface volumes corresponding to multiple time samples. The values of the points in the grid represent attributes of the data, which values vary over time corresponding to variation in the energy emitted at each point in the subsurface.

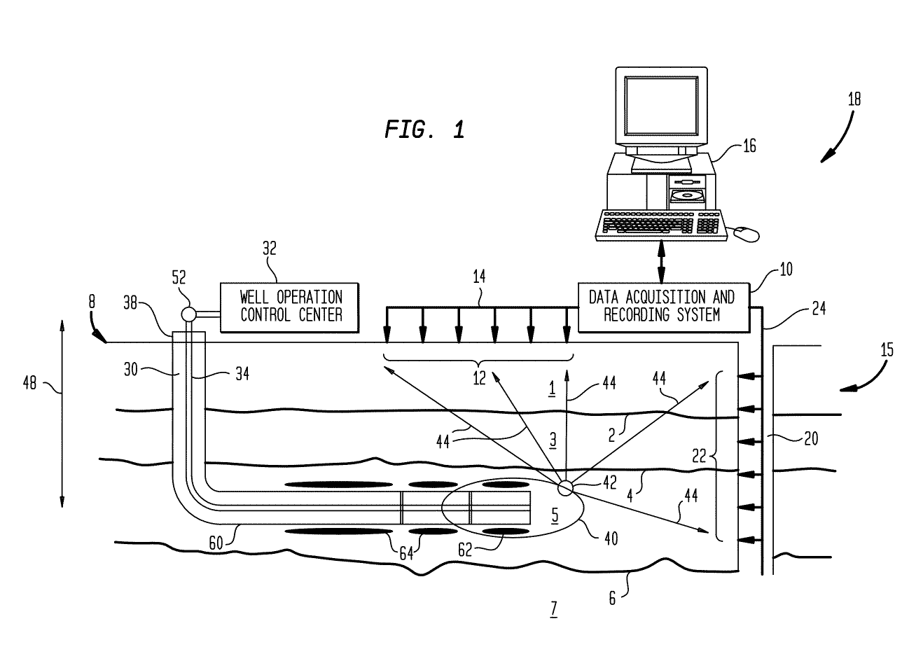

FIG. 1 shows one example of how microseismic data are acquired during a hydraulic fracturing operation. FIG. 1 shows a cross-sectional view of the earth with geologic layers 1, 3, 5 and 7. The interfaces between these layers are 2, 4 and 6, and the surface of the earth is shown at 8. It will be understood by those of ordinary skill in the art that this is a very simplified model of the geology in the subsurface of the earth. Vertical well bore 30 has been drilled and deviated to a horizontal well bore 60. Horizontal well bore 60 is at a depth 48 below Kelly bushing 52. Depth 48 is typically several thousands of feet, often 10,000-14,000 feet. One or more additional boreholes 20 may have been drilled for previous wells, or may have been drilled specifically for the purpose of placing downhole sensors 22. Such purpose-drilled boreholes 20 are typically not drilled to the same depths as production well bores 30.

A hydraulic fracturing operation is shown in progress in horizontal wellbore 60. Under the control and direction of well operation control center 32, hydraulic fracturing fluid is pumped at high pressure through pipe 34 into vertical wellbore 30 and hence into horizontal wellbore 60. The high pressure forces fracturing fluid out through perforations in wellbore 60 into zones 62 in hydrocarbon producing geologic formation 5 around wellbore 60. The high pressure of the fluid creates fractures or enhances existing fractures in surrounding subsurface volume 40 within formation 5, causing one or more releases of seismic energy at point of fracture 42. The fracturing process can be repeated multiple times at different locations within wellbore 60 to fracture additional zones 64.

This seismic energy propagates from point of fracture 42 through subsurface 15 of the earth as a series of acoustic wavefronts or seismic waves 44, which are then sensed by surface sensors 12 disposed along surface 8 and/or downhole sensors 22 disposed in borehole 20, converted into electrical, optical and/or magnetic analog or digital signals, and recorded by data acquisition and recording system 10 using techniques and equipment well known in the art. The electrical, magnetic, or optical analog or digital signals generated by sensors 12 and 22 are proportional to the displacement, velocity or acceleration of the earth at locations corresponding to sensors 12 and 22, where such displacement, velocity or acceleration is caused by seismic wavefront 44 arriving at the locations of sensors 12 and/or 22, and are recorded as data by recording system 10. As further shown in FIG. 1, data acquisition, processing and interpretation/analysis system 18 comprises surface sensors 12 and downhole sensors 22 operably connected to data acquisition and recording system 10, and data processing computer 16 operably connected to data acquisition and recording system 10.

According to one embodiment, data may be recorded, processed and analyzed or interpreted while fracturing is occurring, thereby enabling near-real-time monitoring of the fracturing process.

Note that FIG. 1 shows only one of many possible embodiments of system 18 for acquiring, processing and interpreting/analyzing microseismic data in a well setting. Data acquisition and processing configurations other than that shown in FIG. 1 may be employed. For example, only surface sensors 12 may be employed or only downhole sensors 22 may be employed, and downhole sensors may be employed in well bore 30 in addition to or instead of in borehole 20. Seismic sensors 12 and 22 may be deployed both along surface 8 and in borehole 20 and/or vertical well bore 30. Any suitable combination of surface sensors 12 and/or downhole sensors 22 may be employed. By way of example, sensors 12 and 22 may be geophones, accelerometers, piezoelectric sensors, hydrophones, or any other suitable acoustic sensor. One-, two- or three-axis geophones may also be used in sensors 12 on surface 8 or in sensors 22 in boreholes 20 and/or vertical well bore 30. Sensors 22 may be cemented in place permanently in borehole 20 or vertical well bore 30, and thereafter used to acquire data for multiple projects. Sensors 22 may also be lowered into borehole 20 on wireline or cable 24. The electrical, magnetic or optical signals from sensors 22 are then transmitted to the data acquisition and recording system 10 along wireline or cable 24. Note further that data acquisition, processing and interpretation system 18 may be employed in land, marine, off-shore rig, and transition zone settings. In addition, multiple data processing computers 16 may be employed, and/or multiple data acquisition and recording systems 10 may be employed.

In other embodiments, signals generated by sensors 12 and/or 22 are transmitted by wireless transmitters to a receiver operably connected to data acquisition and recording system 10. In still other embodiments, the electrical, magnetic and/or optical signals generated by sensors 12 and/or 22 are stored as data in solid state or other memory or recording devices associated with one or more sensors 12 and/or 22. The memories or recording media associated with the recording devices may be periodically collected or polled, and the data stored therein uploaded to data acquisition and recording system 10.

Other embodiments include, but are not limited to, the recording of the seismic waves created by the energy released by explosive charges during the perforation of vertical wellbore 30 or horizontal wellbore 60. When vertical wellbore 30 and horizontal wellbore 60 are cased with a metal pipe or casing, the casing must be perforated so that oil or gas may flow into pipe 34 and thence to surface of the earth 8 at wellhead 38. Small explosive charges are used to perforate the casing and create perforations through which oil or gas may then flow. Perforation is also required before a hydraulic fracturing operation can take place, to allow the hydraulic fracturing fluids to flow into the surrounding formations.

Still other configurations and embodiments may be employed to locate, measure and analyze faults in the subsurface of the earth by microseismic detection and processing means, such as, for example, sensing, recording and analyzing seismic energy originating from naturally occurring events, such as slippage along faults, settling or tilting of the subsurface, earthquakes, and other naturally-occurring events.

Data recorded by data acquisition and recording system 10 are typically, although not necessarily, in the form of digitally sampled time series commonly referred to as seismic traces, with one time series or seismic trace corresponding to each sensor 12 or 22. Each value in the time series is recorded at a known time and represents the value of the seismic energy sensed by sensors 12 and 22 at that time. The data are recorded over a period of time referred to as the data acquisition time period. The data acquisition time period varies depending on the objective of the seismic survey. When the objective of the survey is to monitor a fracturing operation, for example, the data acquisition time period may be in hours or even days. When the objective of the survey is to acquire data associated with perforating a well, the data acquisition time period is much shorter and may be measured, by way of example, in seconds or minutes.

It is usual to record more data than is required for a given survey objective. For example, when monitoring a fracturing operation, recording may begin several minutes before the fracturing operation is scheduled and continue until a time beyond which it is unlikely that any further energy will be released as a result of the fracturing process. Such a process may be used to record the ambient seismic field before and/or after fracturing, production, halt of production, or perforation operations.

Once the seismic data have been recorded, they must be processed and converted to produce a useful display of information. In at least some microseismic data processing techniques, the Source Scanning Algorithm or some variation of the algorithm is used to determine the point at which the microseismic energy originated.

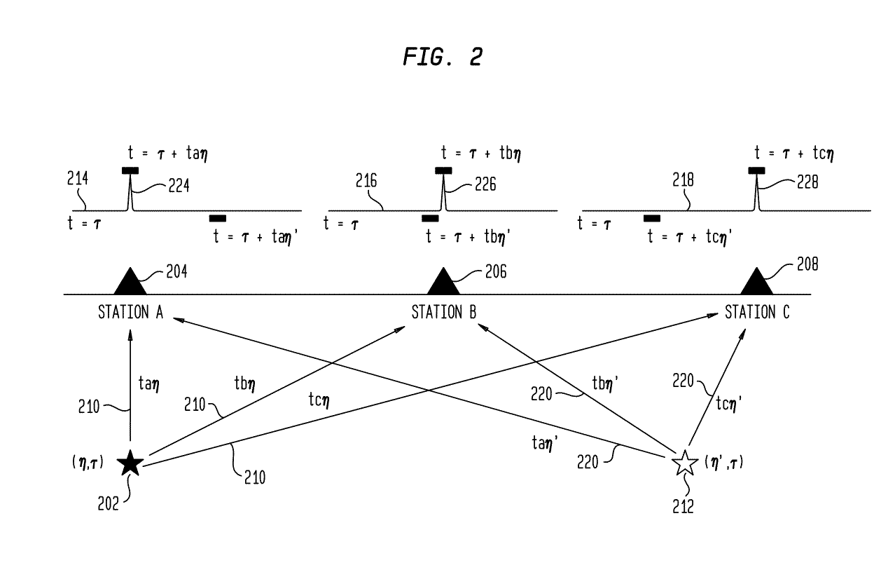

FIG. 2 shows one of the methods for earthquake monitoring as described in “The Source-Scanning Algorithm: mapping the distribution of seismic sources in time and space” by Honn Kao and Shao-Ju Shan, Geophys. J. Int. (2004) 157, 589-594 (hereafter “the Kao publication”).

In FIG. 2, microseismic event 202 occurs at (η,τ) in the subsurface at point rᵢ and time τ. Seismic energy 210 from event 202 takes some time to reach surface sensors at station A 204, station B 206 and station C 208. The travel time of seismic energy 210 to station A 204 is t_{aη}, the travel time to station B 206 is t_{bη}, and the travel time to station C 208 is t_{cη}. Seismic data traces 214, 216 and 218 are recorded at station A 204, station B 206 and station C 208 respectively. As seen in FIG. 2, seismic energy 210 is recorded at station A 204 at time t=τ+t_{aη}, at station B 206 at time t=τ+t_{bη}, and at station C 208 at time t=τ+t_{cη}. Seismic data traces 214, 216 and 218 are shifted in time to compensate for the travel times from point η to each sensor. For example, trace 214 is shifted by t_{aη} such that the energy appears at time 224=(τ+t_{aη})−t_{aη}=τ. Traces 216 and 218 are shifted by t_{bη} and t_{cη} respectively to times 226 and 228. Now all three traces show the seismic energy at time t=τ. When the traces are summed, the energy adds at time t=τ. The Kao publication refers to this as the “brightness function”. If the semblance values (defined below) for traces 214, 216 and 218 is computed, they show a high degree of similarity at time t=τ. This confirms that the microseismic event did originate at or proximate to subsurface location η at time τ.

If, however, the same process is applied at subsurface location η′, at time τ, the result is different. If microseismic event 212 had occurred at (η′,τ) in the subsurface at point η′ and time τ, then the travel time for the seismic energy 220 to reach station A 204 would be t_{aη′}. Similarly, the travel times to station B 206 and station C 208 would be t_{bη′} and t_{cη′} respectively. Energy 220 from the microseismic event would be expected to arrive at the surface sensors at times (τ+t_{aη′}), (τ+t_{bη′}) and (τ+tc_{η′}). As shown in FIG. 2, there is reduced microseismic energy at these times on the seismic traces, and whether they are summed or the semblance is computed, there is reduced indication of a microseismic event. It is therefore possible to conclude that no microseismic event 212 occurred at (η′,τ), that is, in the subsurface at point η′ and time τ. In the terminology of the Kao publication, the brightness function has a lower value at this point.

Semblance is a measure of the similarity of seismic traces, and is defined as the energy of the stacked trace divided by the mean energy of all traces that contribute to the stack. See “Semblance and Other Similarity Measurements”, M. T. Taner, Rock Solid Images, November 1996, the disclosure of which is incorporated herein in its entirety. If f_{i j} is the j th sample of the i th trace, then the semblance coefficient S_{c} is

$${S}_{c} ( k ) = \frac{{\sum }_{j = k - N / 2}^{k + N / 2} {[ {\sum }_{i = 1}^{M} {f}_{ij} ]}^{2}}{M {\sum }_{j = k - N / 2}^{k + N / 2} {\sum }_{i = 1}^{M} {( {f}_{ij} )}^{2}} ,$$

where M traces are summed; and the coefficient is evaluated for a window of width N samples centered at time sample k.

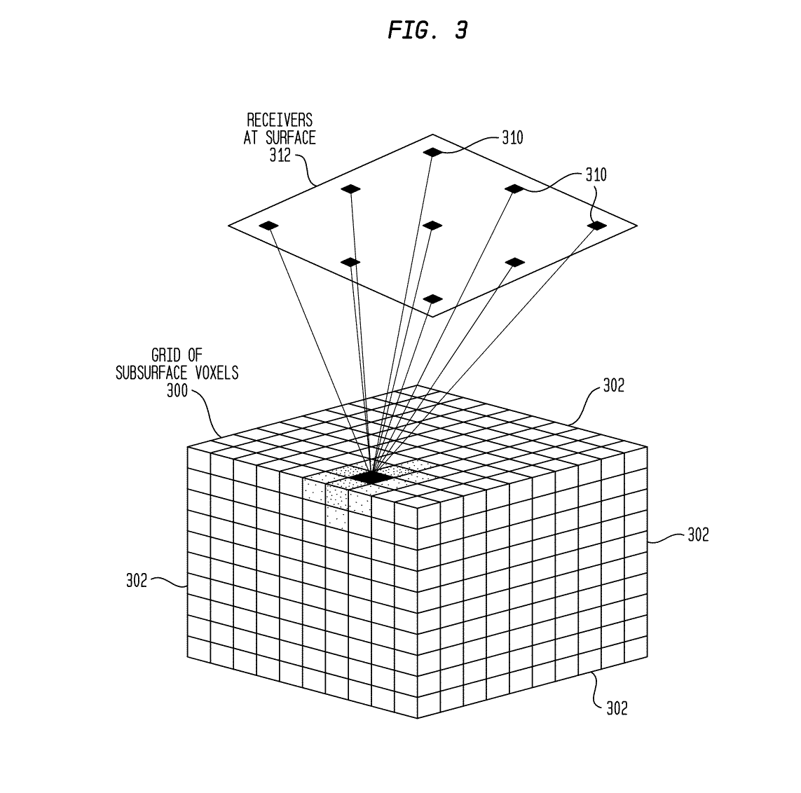

As shown in FIG. 3, the method used in the Source-Scanning Algorithm (SSA) is to examine a volume of the subsurface over a selected time interval, looking at points in the subsurface to see if a microseismic event could have originated at that point. The subsurface of the earth is divided into a three-dimensional grid 300 containing elements 302 which are referred to as “voxels”. Just as a “pixel’ is an element within a two-dimensional area, a “voxel’ is an element within a three-dimensional volume, each cell or voxel within the grid representing a possible location of the source of a microseismic event.

Data are recorded at N sensors 310 on surface 312 as a series of times and amplitudes, the time series for each sensor being referred to as a “trace”. The time values correspond to the time at which the seismic energy arrived at the sensor, which must be later in time than when the seismic energy was emitted from the source in the subsurface. Using a known or estimated velocity model, the travel time and travel path from the voxel to each sensor is computed for each voxel 302 in subsurface grid 300. A set of data is selected, corresponding to a chosen time interval. For each voxel 302 in subsurface grid 300, the trace recorded at each of the N sensors 310 has the appropriate computed travel time shift applied to it. Thus the seismic energy for each trace is corrected in time to the time when it was emitted. The result is a set of N traces which may be considered to have originated at this voxel 302. These traces are then summed or “stacked” together.

Where the voxels coincide with the location of actual microseismic events the microseismic event energy is “flattened”, or aligned in time, by the subtraction of the travel times, and the energy from each trace will add when the traces are stacked, thereby representing an event location. If no microseismic event occurred at this voxel, then the resulting stacked trace will show the random background noise. This process is repeated for each voxel in the subsurface volume of interest.

In other implementations of the source scanning method, the semblance of the N time-shifted traces is computed. The semblance function shows the similarities between traces, and has a high value if a seismic event originated at the voxel, and a low value if there is nothing more than random background noise at this voxel. The result is a representation of the subsurface for the selected time interval showing where microseismic events may have occurred. Yet other implementations use different attributes of the data.

While various algorithms may be used to transform the acquired data, the end result is typically the same: a series of spatial volumes are produced, where each spatial volume is associated with a given data subset, and each data subset corresponds to a given time window. The values corresponding to the voxels within the spatial volume represent the amount of energy emitted from each voxel during a given time window. The energy emitted from each voxel during a given time window may be represented by different attributes of the data, including, but not limited to, semblance, amplitude, absolute amplitude, reflection strength (the amplitude of the envelope of the seismic wave), polarity or apparent polarity, phase, frequency, and other attributes of seismic data which will be apparent to those skilled in the art. See “Complex seismic trace analysis”, M. T. Taner, F. Koehler, and R. E. Sheriff, Geophysics, Vol. 44, No. 6 (June 1979), pp 1041-1063, hereinafter “Complex seismic trace analysis”, the disclosure of which is incorporated herein in its entirety.

Typically the energy released during hydraulic fracturing is of a very low level, usually below zero on the Richter scale, hence the amount of energy that reaches the surface and is detected by the surface sensors is extremely small. Surface or near-surface microseismic monitoring is limited by noise contamination, as shown by many authors. See “Comparison of surface and borehole locations of induced seismicity”, Eisner et al., Geophysical Prospecting, Vol. 58, Issue 5, pp 809-820, September 2010, the disclosure of which is incorporated herein in its entirety. See also “Comparison of simultaneous downhole and surface microseismic monitoring in the Williston Basin”, Diller and Gardner, 2011 Annual International Meeting, SEG, Expanded Abstracts, the disclosure of which is incorporated herein in its entirety. The presence of a noise burst or spike on one trace can create a high value in the stacked data which may be falsely interpreted as a microseismic event. Hence the results of conventional microseismic processing contain many false events, reducing the level of confidence that may be placed in the results. The method described herein avoids these problems by creating and analyzing sub-stacks.

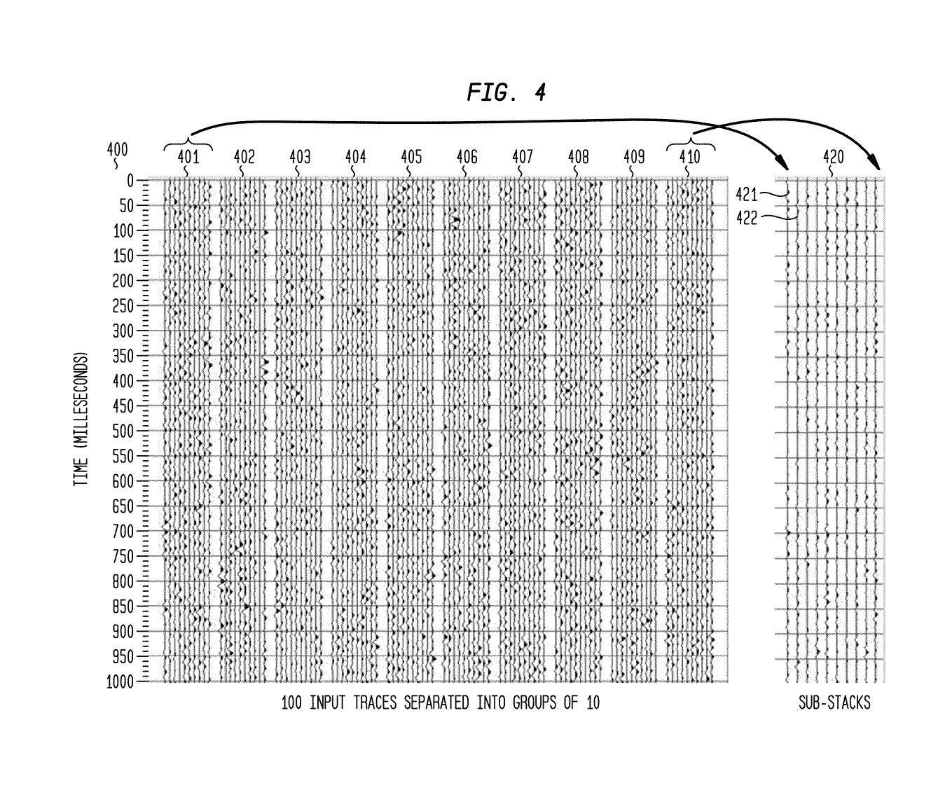

FIG. 4 depicts the process of creating sub-stacks. Seismic data display 400 contains 10 groups of seismic traces 401,402, 403, 404, 405, 406, 407, 408, 409 and 410, each containing 10 traces. In the embodiment described herein the input collection of traces are first corrected for the travel times from a particular subsurface voxel to the receivers as part of the source scanning algorithm process as described above. The collection of traces is separated into groups 401 through 410, with the groups typically comprised of traces recorded at locations that have the closest spatial proximity to each other. Each group of traces is then summed to produce a single sub-stack trace per group, instead of summing all traces to create a single trace as would normally be done in microseismic data processing. In the embodiment shown in FIG. 4, the 100 traces are separated into 10 groups of 10, and each group produces one sub-stack trace for an output data set 420 of 10 traces. Thus the traces in group 401 are stacked to create output trace 421, the traces of group 402 are stacked to create output trace 422, and so on.

Although the embodiment described above describes “stacking” as the process of summing the traces, it will be understood by those of skill in the art that the term “stacking” can also refer to other methods of combining data from multiple seismic traces in such a way as to enhance the desired signal while reducing the effects of noise. The term “stacking” in this disclosure should be understood to include all methods commonly accepted within the industry of combining multiple seismic traces to produce a single trace for analysis. These methods include, but are not restricted to, summing of the trace amplitudes, computing the median, computing the trimmed mean sum, diversity stacking and various weighted stacking methods. In diversity stacking, amplitude values exceeding some predetermined threshold are excluded and amplitude values below this threshold are summed. These methods are listed as examples only and are not to be read as limitations. Other methods will be known to those of skill in the art and may be used interchangeably with the examples listed in this description.

In some embodiments of the present method, a variation of the source scanning algorithm is employed. Rather than summing or stacking the groups of traces to create sub-stacks, the semblance of groups of the time-shifted traces is computed. The semblance has a high value if a seismic event originated at the voxel, and a low value if there is nothing more than random background noise at this voxel. The result is a representation of the subsurface for the selected time interval showing where microseismic events may have occurred. Yet other implementations use different attributes of the data.

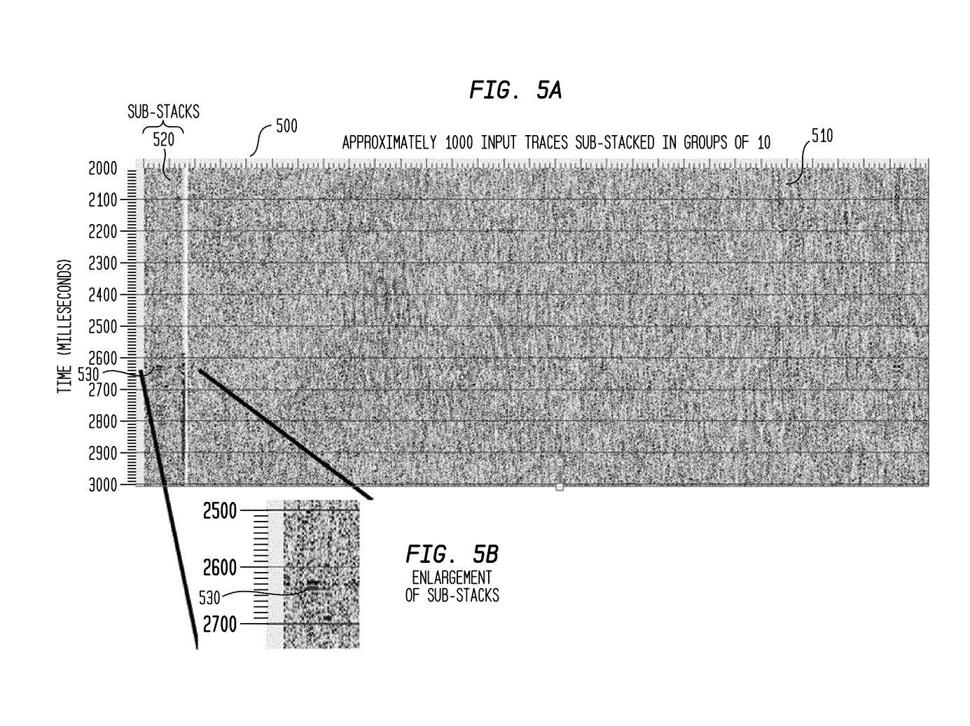

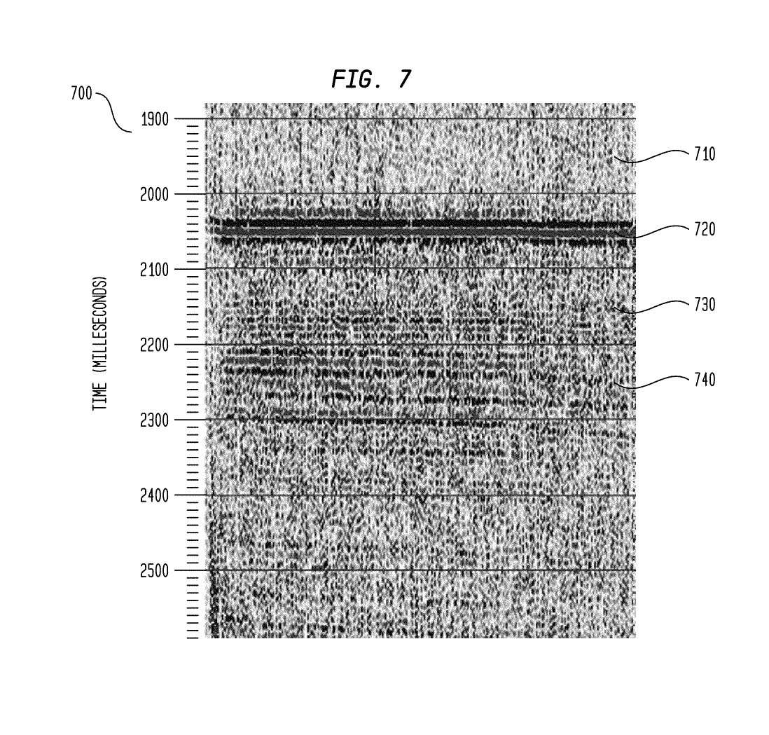

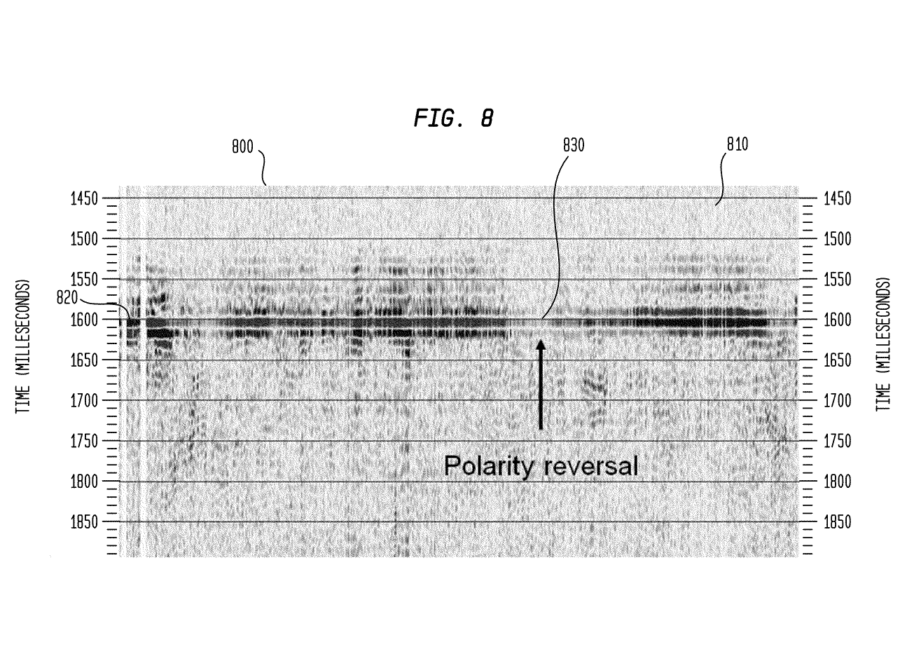

It should be noted that FIGS. 5 through 8 are shown in gray scale. Normally these displays of seismic data would be shown as industry standard polarity displays, using magenta and blue color coding. The gray scale is used to comply with the requirements of the U.S. Patent and Trademark Office. The conversion to gray scale is not part of the method described herein and no inferences should be drawn from its limited use in this disclosure. Those of ordinary skill in the art will recognize that the reduction to gray scale involves a loss of information, and a serious reduction in the ability to readily distinguish real microseismic events from false events or noise. Examples of the use of the polarity display are shown in FIGS. 7(c) and 7(f), and FIG. 8(c) of the reference “Complex seismic trace analysis”.

Referring now to FIG. 5A, seismic data display 500 shows 1000 input microseismic traces 510 which have been sub-stacked in groups of ten traces. The sub-stacked traces 520 are shown at the left of display 500. An enlarged section of sub-stacked traces is shown in FIG. 5B, with a small microseismic event 530 visible in both the sub-stack data of FIG. 5A and the enlargement of FIG. 5B. As is common with microseismic data, event 530 is not visible in original traces 510, but is evident in sub-stack traces 520. Event 530 is clearly visible across most of sub-stack traces 520. Event 530 would also show as a microseismic event when all the data traces 510 are stacked to create one output trace. In the example shown, the existence of event 530 was confirmed by observation of the same event in data that was recorded in a borehole very close to the location of the event.

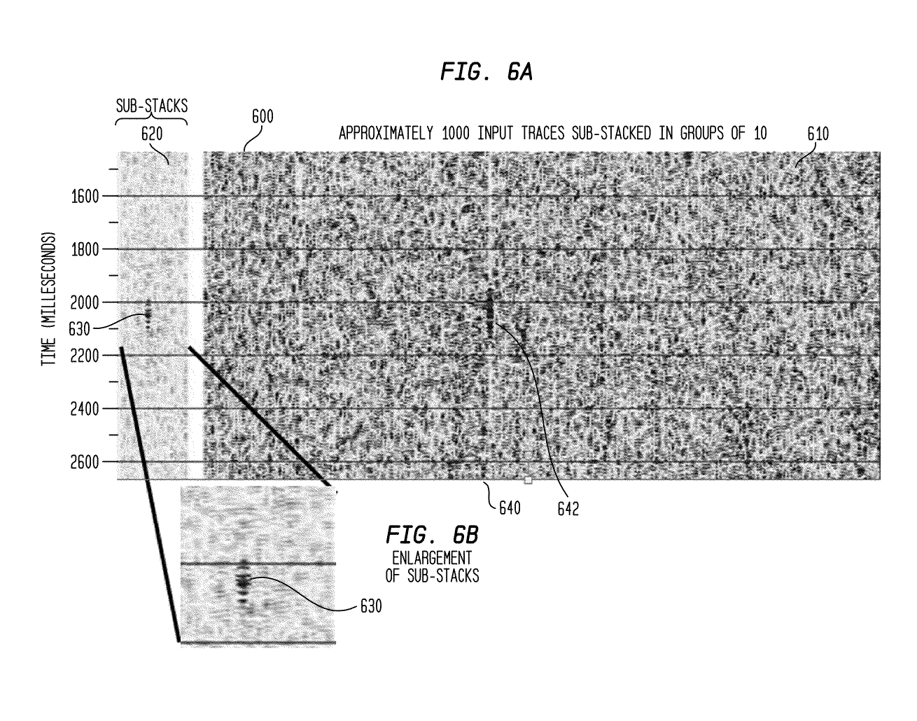

FIG. 6A shows seismic data display 600 with the original microseismic data traces 610 and the sub-stack traces 620 for a false event 630. False event 630 appears to have been caused by a noise burst 642 on a small number of traces 640. Unlike the real microseismic event 530 seen in FIG. 5A, which is not visible on the original traces, the false event is visible near the center of the display of the original traces. FIG. 6B shows an enlargement of a section of sub-stacks 620. Even though it appears on only a few input traces, the magnitude of noise burst 642 would cause it to be visible when all the traces are stacked together, thus creating a false event. The non-existence of the event was confirmed by observation of the same time period in data that was recorded in a borehole very close to the apparent location of the false event.

Comparing FIG. 5A and FIG. 6A, and FIG. 5B and FIG. 6B, it is seen that the embodiments described herein enable a trained observer to quickly and with confidence distinguish between a small real microseismic event and a false event caused by a noise burst. In other embodiments, computer algorithms are applied to the sub-stack data to enable automated discrimination between real events and false events.

FIG. 7 shows a seismic data display 700. Display 700 shows microseismic traces 710 from a large microseismic event 720 at about 2050 milliseconds, and corresponding reverberations 730, 740 are seen below 2150 milliseconds. Reverberations are caused by internal reflections within the earth as the seismic energy carries to the surface. Evidence of reverberations is part of the criteria that are used to recognize real microseismic events. Reverberations can be caused in various ways, and all seismic events are accompanied by reverberations. A real microseismic event will release seismic energy as sound waves, some of which will reach the surface directly. Some energy may be reflected, in some cases multiple times, on its way to the surface. Some energy will reach the surface, be reflected downwards, and then be reflected back to the surface. Some energy will travel downwards and be reflected back to the surface from geologic interfaces deeper in the earth. For any large microseismic event, such reverberations are evidence that seismic energy has originated within the subsurface. The absence of such reverberations is evidence that the event is not real and that a noise burst was responsible for the event.

The reverberations for small microseismic events are harder to detect and use as criteria for distinguishing between real events and false events caused by noise bursts. In some embodiments of the present method, sub-stacks of the data traces are created as described above, and examined for reverberations. In the sub-stack data, both the microseismic event and the reverberations are more visible, enabling visual determination of whether the reverberations are present and allowing the trained observer to distinguish between real and false events.

In other embodiments, automated methods are used to discriminate between real and false microseismic events by evaluating the presence or absence of reverberations. One such embodiment uses the average of the semblance over a sliding window in time to aid in the recognition of reverberations. Other embodiments use a subset of the highest semblance values over a sliding window to aid in the recognition of reverberations.

FIG. 8 shows seismic data display 800 containing microseismic traces 810. At approximately 1600 milliseconds there is visible a large microseismic event 820 with a polarity reversal 830. Displaying the polarity or apparent polarity of seismic data has proved to be a useful technique for analysis and interpretation of the seismic data since the 1970s. See the reference “Complex seismic trace analysis. The industry convention is that positive apparent polarity is displayed as color-coded shades of magenta, and negative apparent polarity as color-coded shades of blue, the intensity of the magenta or blue hue being proportional to the reflection strength of the seismic data. The color-coded values are usually overlaid on a conventional seismic display. Evidence of polarity reversals is one of the criteria that may be used to recognize real microseismic events. Polarity reversals are caused by the radiation pattern of microseismic events that have a slip or double-couple source mechanism. When slip occurs along a fault or fracture, the two sides of the fracture move in opposing directions relative to each other. Depending on the azimuth from the event to the sensor, the initial motion of the fracture may create a compressional signal or a tensional signal, with opposite polarity. Therefore the sensors in a microseismic array will record the seismic energy from an event with different polarities, corresponding to their positions relative to the event. In some cases, this could result in the data cancelling out when stacked and the microseismic event not being detected. In contrast, noise bursts occur on just a few traces and do not exhibit this polarity reversal behavior.

Using sub-stacks, this same polarity effect can be seen even in small microseismic events. Each sub-stack contains traces that are close to each other, and hence will record data with similar polarity. However, the different sub-stacks may show differing polarities. It is therefore possible for a trained observer to visually identify on the sub-stacks small events that might produce very low values when all the traces were stacked, and might thus be overlooked. Further, the variation in polarity may provide information about the direction of first motion of the microseismic event, and hence information about the direction of stress in the subsurface.

Some embodiments of the present method enable recognition of polarity reversals in sub-stacks by automated methods that discriminate between small microseismic events and false events, using semblance that is computed over spatially adjacent groups of sub-stacks instead of all sub-stacks.

In other embodiments, the sub-stack traces are formed as the semblance of the traces in each group, or in yet other embodiments, from a semblance-weighted stack of the traces in each group.

The method and embodiments described above refer to surface sensors, but the method is applicable to other embodiments such as analyzing microseismic data recorded using sensors placed in a borehole. Other embodiments include applying the methods described herein to data acquired using buried arrays, wherein the data are acquired using sensors buried in shallow boreholes drilled for the purpose.

The method and embodiments described herein provide a robust method of discriminating small microseismic events from false events, where other methods have failed.

It is noted that many of the structures, materials, and acts recited herein can be recited as means for performing a function or step for performing a function. Therefore, it should be understood that such language is entitled to cover all such structures, materials, or acts disclosed within this specification and their equivalents, including any matter incorporated by reference.

It is thought that the apparatuses and methods of embodiments described herein will be understood from this specification. While the above description is a complete description of specific embodiments, the above description should not be taken as limiting the scope of the patent as defined by the claims.

Other aspects, advantages, and modifications will be apparent to those of ordinary skill in the art to which the claims pertain. The elements and use of the above-described embodiments can be rearranged and combined in manners other than specifically described above, with any and all permutations within the scope of the disclosure.

Although the above description includes many specific examples, they should not be construed as limiting the scope of the method, but rather as merely providing illustrations of some of the many possible embodiments of this method. The scope of the method should be determined by the appended claims and their legal equivalents, and not by the examples given.

What is claimed is:

1. A method for discriminating between small microseismic events and false events comprising:
obtaining a set of microseismic data traces recorded at a plurality of receivers;
identifying at least one candidate event by applying a source scanning algorithm;
for each candidate event;
identifying an apparent location of the candidate event;
correcting the microseismic data traces for the travel times from the apparent location of the candidate event to each corresponding receiver;
organizing the time-corrected traces into a plurality of groups of traces;
creating a plurality of sub-stack traces from the traces within each group; and
analyzing the sub-stacks to classify the candidate event as a microseismic event or a false event.

2. The method of claim 1 wherein creating a plurality of sub-stack traces from the traces within each group further comprises applying one method selected from the group consisting of stacking the trace amplitudes, summing the trace amplitudes, computing the median, computing the trimmed mean sum, diversity stacking and weighted stacking.

3. The method of claim 1 wherein creating a plurality of sub-stack traces from the traces within each group further comprises computing the semblance of the traces within the group.

4. The method of claim 1 wherein creating a plurality of sub-stack traces from the traces within each group further comprises computing the semblance-weighted stack of the traces within the group.

5. The method of claim 1, wherein analyzing the sub-stacks further comprises displaying the sub-stacks to enable an observer to classify the candidate event as a microseismic event or a false event.

6. The method of claim 1, wherein analyzing the sub-stacks further comprises applying automated criteria to classify the candidate event as a microseismic event or a false event.

7. The method of claim 1 wherein the groups of traces contain between 10 and 25 traces per group.

8. A method for discriminating between small microseismic events and false events comprising:
obtaining a set of microseismic data traces recorded at a plurality of receivers;
identifying at least one candidate event by applying a source scanning algorithm;
for each candidate event;
identifying an apparent location of the candidate event;
correcting the microseismic data traces for the travel times from the apparent location of the candidate event to each corresponding receiver;
organizing the time-corrected traces into a plurality of groups of traces;
creating a plurality of sub-stack traces from the traces within each group; and
analyzing the reverberations in the sub-stacks to classify the candidate event as a microseismic event or a false event.

9. The method of claim 8 wherein creating a plurality of sub-stack traces from the traces within each group further comprises applying one method selected from the group consisting of stacking the trace amplitudes, summing the trace amplitudes, computing the median, computing the trimmed mean sum, diversity stacking and weighted stacking.

10. The method of claim 8, wherein creating a plurality of sub-stack traces from the traces within each group further comprises computing the semblance of the traces within the group.

11. The method of claim 10, wherein the semblance values are averaged over a sliding window.

12. The method of claim 8, wherein creating a plurality of sub-stack traces from the traces within each group further comprises computing the semblance-weighted stack of the traces within the group.

13. The method of claim 8, wherein the sub-stacks in a time window near the candidate event are automatically evaluated for the highest semblance.

14. The method of claim 8, wherein the groups of traces contain between 10 and 25 traces per group.

15. A method for discriminating between small microseismic events and false events comprising:
obtaining a set of microseismic data traces recorded at a plurality of receivers;
identifying at least one candidate event by applying a source scanning algorithm;
for each candidate event;
identifying an apparent location of the candidate event;
correcting the microseismic data traces for the travel times from the apparent location of the candidate event to each corresponding receiver;
organizing the time-corrected traces into a plurality of groups of traces;
creating a plurality of sub-stack traces from the traces within each group; and
analyzing polarity reversals in the sub-stacks to classify the candidate event as a microseismic event or a false event.

16. The method of claim 15 wherein creating a plurality of sub-stack traces from the traces within each group further comprises applying one method selected from the group consisting of stacking the trace amplitudes, summing the trace amplitudes, computing the median, computing the trimmed mean sum, diversity stacking and weighted stacking.

17. The method of claim 15 wherein creating a plurality of sub-stack traces from the traces within each group further comprises computing the semblance of the traces within the group.

18. The method of claim 15 wherein creating a plurality of sub-stack traces from the traces within each group further comprises computing the semblance-weighted stack of the traces within the group.

19. The method of claim 15, wherein analyzing polarity reversals further comprises displaying the sub-stacks to enable an observer to classify the candidate event as a microseismic event or a false event.

20. The method of claim 15, wherein analyzing polarity reversals further comprises applying automated criteria to classify the candidate event as a microseismic event or a false event based on polarity reversals.

21. The method of claim 15, wherein analyzing polarity reversals further comprises using semblance that is computed over spatially adjacent groups of sub-stacks.
